(19) United States
(12) Patent Application Publication
(10) Pub. No.: US 2007/0254797 A1
(43) Pub. Date: Nov. 1, 2007

(54) Glass Composition for Lamp and Lamp Manufactured From the Same

(76) Inventors: Junko Abe, Osaka (JP); Tomoko Atagi, Osaka (JP); Masanobu Ito, Kyoto (JP); Ryosuke Sawa, Osaka (JP); Yasuro Niguma, Osaka (JP); Hiroya Watanabe, Osaka (JP)

Correspondence Address: SNELL & WILMER L.L.P. (Matsushita), 600 ANTON BOULEVARD, SUITE 1400, COSTA MESA, CA, 92626, US

(21) Appl. No.: 11/597,179

(22) PCT Filed: May 30, 2005
(86) PCT No.: PCT/JP05/09902

§ 371 Date: Nov. 21, 2006

(30) Foreign Application Priority Data
May 31, 2004 (JP) 2004-162051

(51) Int. Cl. C03C 3/089

(52) U.S. Cl. 501/72; 314/136; 501/65

(57) ABSTRACT

A glass composition for lamps includes: SiO₂ (silicon dioxide) as a main component; Na₂O (sodium oxide) in the range of 12 to 17 wt. %; MgO (magnesium oxide) in the range of 2.5 to 4 wt. %; and CaO (calcium oxide) in the rage of 5.3 to 7.3 wt. %, wherein the total content of MgO and CaO is in the range of 8 to 11 wt. %. Thereby, lamps can be manufactured at relatively low costs that exhibit superiority in fracture resistance, workability, erosion resistance with respect to the inner surface of a furnace, and suppressing the elution of alkali component.

### TECHNICAL FIELD

The present invention relates to a glass composition for lamps and also to a lamp manufactured from the glass composition.

### BACKGROUND ART

For manufacture of an arc tube of a florescent lamp, the kind of glass exhibiting excellent workability in bending, coupling, and sealing is used. In order to enhance the workability of glass, it is a well-known technique to increase the content of alkalimetal oxides, such as Li₂O (lithiumoxide), Na₂O (sodium oxide), and K₂O (potassium oxide). It is preferable to increase the content of Na₂O that is less expensive and allows easy adjustment of its content. However, it is not easy to increase the Na₂O content for the following reasons.

As the amount of Na₂O increases, the amount of Na (sodium) within the glass proportionally increases. Na is one of the alkali metal components that are most easily eluted from glass. If Na elutes from the glass and reacts with Hg (mercury) filled in an arc tube, amalgam is generated and adhered to the inner surface of the tube. As a result, the appearance of the arc tube is deteriorated and/or the inner surface quality of the arc tube is reduced. Furthermore, the amalgam generation consumes Hg filled within the arc tube. Hence the light emission efficiency of the lamp decreases and the life of the lamp shortens. In addition, in compensation for Hg expected to be consumed, it is required to fill an extra amount of Hg in the tube in advance. In order to avoid the above-described problems resulting from amalgam generation, it is preferable that the Na₂O content is as low as possible.

In light of the above, conventional arc tubes are manufactured from glass whose workability is enhanced by using glass components other than Na₂O. One commonly known example of such glass is so-called lead-glass containing PbO (leadoxide) Other examples include glass with a high content of strontium oxide (SrO) or barium oxide (BaO) as disclosed in Patent Literatures 1 and 2.
Patent Literature 1: Laid-Open Patent Publication No. 9-12332
Patent Literature 2: Laid-Open Patent Publication No. 2003-40643

### DISCLOSURE OF THE INVENTION

The Problems to be Solved by the Invention

Recently, however, lead-glass is subject to official restrictions and thus discouraged to be used. On the other hand, SrO and BaO used in the glass disclosed in Patent Literatures 1 and 2 are costly glass components that cannot be obtained from natural mineral resources. Besides, glass containing SrO and BaO is so fragile and results in low productivity in the manufacturing process and insufficient strength of finished lamps. In addition, the inner surfaces of melting furnaces are prone to erosion by SrO and BaO. Hence, melting of the glass with a high content of SrO or BaO in a furnace inevitably increases maintenance costs of the furnace.

In order to address the above-described problems, a primary objective of the present invention is to provide, at lower cost, a glass composition for lamps that is excellent in workability and strength, that produces less alkali elution, and that is free from the risk of furnace erosion. Another objective is to provide lamps manufactured from such a glass composition.

Means to Solve the Problems

In an effort to achieve the above-described objectives, a glass composition in accordance with the present invention is a glass composition for a lamp containing the following that are expressed in terms of oxides: SiO₂ (silicon dioxide) as a main component; Na₂O in the range of 12% to 17% by weight; MgO in the range of 2.5% to 4% by weight; and CaO in the range of 5.3% to 7.3% by weight. The total content of MgO and CaO is in the range of 8% to 11% by weight.

Na₂O is alkali metal oxide known to decrease the viscosity of glass by cutting the bonds of the silica network structure of the glass. In comparison with the other components, Na₂O exhibits the outstanding effect of decreasing the glass viscosity and is available at relatively low cost. Hence, the presence of Na₂O is useful for increasing the workability of glass, as long as the content falls in the range of 12% to 17% by weight. If the Na₂O content falls below 12% by weight, the viscosity of glass increases whereas the workability decreases. On the other hand, if the Na₂O content exceeds 17% by weight, the water-resistance of the glass decreases.

MgO and CaO are both alkaline-earth metal oxides that are known to decrease the viscosity of glass by cutting the bonds of the silica network formation within the glass, and also to increase the water-resistance of the glass. In addition, these components are likely to impose effects on the glass properties such as chemical resistance, devitrification, and crystallization. As for the respective contents, MgO is in the range of 2.5% to 4% by weight, CaO is in the range of 5.3% to 7.3% by weight, and the total content of MgO and CaO is in the range of 8% to 11% by weight.

If at least either of the contents of MgO and CaO falls below the lower limit of the respective range, the chemical resistance of the glass decreases. On the other hand, if at least either of the contents of MgO and CaO exceeds the upper limit of the respective range, the viscosity curve becomes steep. In other words, the glass cools too quickly during work processing. Accordingly, the workability of glass decreases rapidly, further leading to lamp productivity decrease.

In accordance with one aspect of the present invention, the glass composition may contain SiO₂ in the range of 65% to 74% by weight. The glass composition may further contain: Al₂O₃ in the range of 1.2% to 2.4% by weight; B₂O₃ in the range of 0.3% to 1.5% by weight; K₂O in the range of 0.9% to 1.9% by weight; and Sb₂O₃ in the range of 0% to 1% by weight.

SiO₂ is a main component that contributes to formation of the network structure of the glass. The SiO₂ content is in the range of 65% to 74% by weight. If the SiO₂ content falls below 65% by weight, the water-resistance of the glass is lowered. If the SiO₂ content exceeding 74% by weight, the viscosity of the glass increases at high temperature, and the workability of the glass significantly decreases.

Likewise, Al₂O₃ is a component that contributes to formation of the network structure of the glass and to increase the chemical resistance of the glass. The Al₂O₃ content is in the range of 1.2% to 2.4% by weight. If the Al₂O₃ content falls below 1.2% by weight, the water-resistance of the glass decreases. On the other hand, if the Al₂O₃ content exceeds 2.4% by weight, the devitrification and/or striae formation take place within the glass, or the viscosity of the glass increases to decrease the workability.

B₂O₃ is a component that contributes to formation of the network structure of the glass, to increase the chemical resistance of the glass, and to decrease the viscosity as the temperature rises high. The content of B₂O₃ is in the range of 0.3% to 1.5% by weight. If the content of B₂O₃ falls below 0.3% by weight, a sufficient increase in chemical resistance and decrease in viscosity cannot be achieved. On the other hand, if the content of B₂O₃ exceeds 1.5% by weight, the chemical resistance decreases, and hence, the furnace erosion takes place.

K₂O is a component that cuts the bonds of SiO₂, and decreases the viscosity of the glass. The content is in the range of 0.9% to 1.9% by weight. If the content of K₂O falls below 0.9% by weight, the viscosity of the glass increases to decrease the workability. On the other hand, if the K₂O content exceeds 1.9% by weight, the water-resistance of the glass decreases.

Sb₂O₃ is a component serving as a fining/clarifying agent of the molten phase glass. The content of Sb₂O₃ is in the range of 0% to 1% by weight. If the content of Sb₂O₃ exceeds 1% by weight, the glass is prone to blackening when the glass in the form of a tube is subject, for example, to bending by heating with a burner.

In accordance with another aspect of the present invention, the glass composition includes substantially no PbO, SrO, and BaO.

Moreover, a lamp in accordance with the present invention is provide with a glass bulb made of the glass composition mentioned above.

Furthermore, in accordance with yet another aspect of the present invention, the lamp is a low-pressure mercury discharge lamp.

In addition, in the lamp in accordance with yet another aspect of the present invention, the glass bulb is a bent glass bulb.

Effects of the Invention

A glass composition in accordance with the present invention is high in Na₂O content. Na₂O is, as described above, a component that decreases the viscosity of glass, hence exhibiting the superior workability. With this superior workability, the glass composition of the present invention is suitable for an arc tube due to its easy-to-bend, -couple, and -seal properties. Here, it should be noted that the term “bent glass bulb” in the present invention would mean a non-linear glass bulb formed by bending a straight glass tube. Typical examples include circular glass bulbs, U-shaped glass bulbs, and spiral glass bulbs.

In the glass composition for lamps of the present invention, the contents of respective components such as MgO and CaO are within the predetermined ranges, so that the amount of alkali elution from the glass is suppressed. As a consequence, amalgam is hardly generated even if the glass composition of the present invention is employed for a lamp such as a low-pressure mercury discharge lamp having an arc tube filled with Hg. Therefore, various disadvantages inherent in the amalgam generation can be overcome, such as worsening of the arc tube appearance, decrease in the luminous flux maintenance factor, and shortening of the longevity of the lamp. Not to mention that it is not necessary to seal an extra amount of Hg within the arc tube.

As described above, the alkali elution amount can be suppressed regardless of a high content of Na₂O. The mechanism achieving the above advantages is presumed that the combined use of MgO and CaO selected from among various components at precise amounts produces a synergistic effect, so that the glass network and the atom radius work to prevent instable migration of Na in the glass. The glass composition in accordance with the present invention is capable of suppressing the Na atom's migration often observed in the silica network formation, and the diffusion of the alkali metal to the florescent slurry during the baking processing.

The glass composition according to the present invention may exclusively contain SiO₂, Al₂O₃, B₂O₃, Na₂O, K₂O, MgO, CaO and Sb₂O₃ and still achieves the above advantages. In addition, such a glass composition exhibits sufficient water-resistance, ease-to-melt property, devitrification, chemical resistance, electrical insulation, and clarity. Besides, owing to the smaller number of components, the glass composition of the present invention achieves an excellent productivity in the manufacturing process, and lower manufacturing costs. Moreover, the use of Li₂O, P₂O₅ (phosphorus pentoxide), and Ti₂O (titanium oxide) are avoided. Li₂O is a costly component and its content is difficult to adjust. P₂O₅ is a component whose content is also difficult to adjust and reduces the chemical resistance. Ti₂O colors the glass.

In addition, the glass composition contains substantially no PbO, SrO and BaO. Thus, the glass is not subject to official restrictions, not expensive, not brittle, and is free from the risk of furnace erosion.

The lamp in accordance with the present invention has a glass bulb manufactured from the glass composition described above. Consequently, the manufacturing costs can be reduced while the strength as a product is increased. In the particular case of the low-pressure mercury discharge lamp, amalgam is hardly generated. Thus, the lamp of the present invention has a longer life and is more environmental friendly than conventional lamps.

The lamp of the present invention may include a bent glass bulb. Yet, owing to the excellent workability of the glass, the bending processing is readily carried out, so that excellent productivity is ensured. Generally, the bending processing involves heating of the glass to the softening point, so that elution of alkali component often occurs. However, the lamp according to the present invention is capable of reducing the risk of amalgam generation even through the manufacturing under the above-sated condition.

### BRIEF DESCRIPTION OF THE DRAWING

FIG. 1 presents a side view of a lamp in accordance with one embodiment of the present invention;

FIG. 2 is a table in which glass compositions and properties are tabulated;

FIG. 3 is a graph showing time-varying change in the amount of Hg consumed in a lamp;

FIG. 4 is a graph showing time-varying change in luminous flux of the lamp;

FIG. 5 is a view illustrating measurement of the amount of alkali elution in accordance with the present invention; and

FIG. 6 is a graph showing a correlation between the amount of alkali elution obtained by conducting the JIS-conformable alkali elution test and electrical conductivity obtained by conducting an alkali elution test in accordance with the present invention.

### DESCRIPTION OF REFERENCE NUMERALS

1 lamp
5 glass bulb

### BEST MODE FOR CARRYING OUT THE INVENTION

One embodiment of the present invention will, hereinafter, be explained with reference to the accompanying drawings.

(About Lamp)

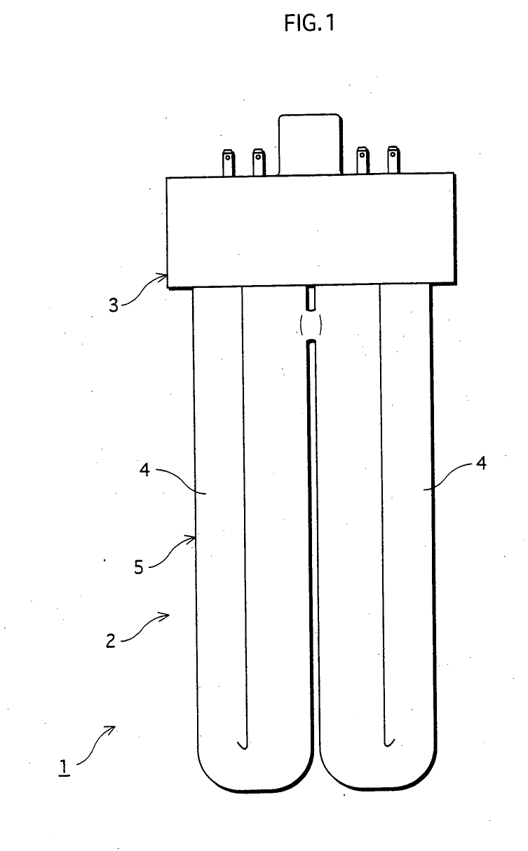

Referring to FIG. 1, the side view of a lamp in accordance with one embodiment of the present invention is shown. The lamp in accordance with the one embodiment of the present invention is, as shown in the figure, a compact fluorescent lamp 1 and has an arc tube 2 and a base 3. The arc tube 2 includes a glass bulb 5 formed by connecting multiple U-shaped glass tubes 4. The glass bulb 5 is manufactured from a glass composition in accordance with the present invention.

It should be noted that the lamp of the present invention is not limited to the compact-type fluorescent lamp, and other variations include florescent lamps of a straight tube type, circular type, and bulb type, and discharge lamps. In addition, a lamp configuration as well as component shapes and sizes are not limited to those discussed in the one embodiment of the present invention.

(About Glass Composition)

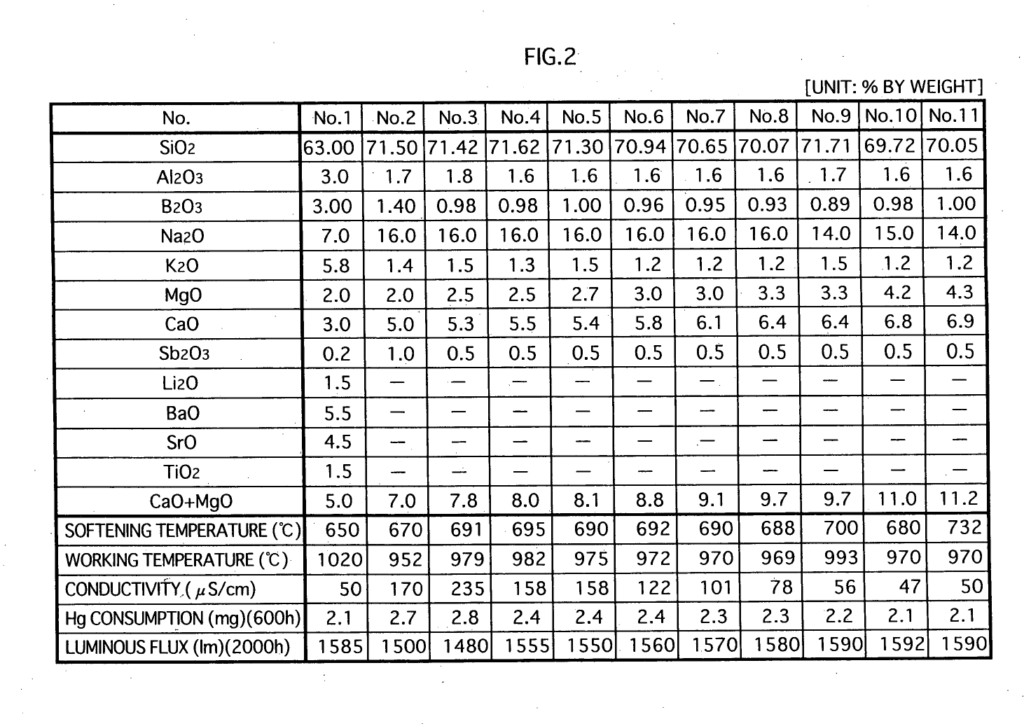

A glass composition in accordance with the present invention is composed of any one of the glass compositions No. 4 through No. 10 in FIG. 2. Note that components of the glass composition of the present invention are not limited to those appearing in the figure. However, from the experiment it has been found that in order to maintain the properties as a lamp, preferably, Na₂O is contained in the range of 12% to 17% by weight, MgO is contained in the range of 2.5% to 4% by weight, CaO is contained in the range of 5.3% to 7.3% by weight, and the total content of MgO and CaO is in the range of 8% to 11% by weight. More preferably, SiO₂ is contained in the range of 65% to 74% by weight, Al₂O₃ is contained in the range of 1.2 to 2.4% by weight, B₂O₃ is contained in the range of 0.3% to 1.5% by weight, K₂O is contained in the range of 0.9% to 1.9% by weight, and Sb₂O₃ is contained in the range of 0% to 1% by weight.

It is noted that the glass composition in accordance with the present invention may include any glass compositions other than those described above within the respective ranges mentioned above. Yet, the glass composition exclusively containing the above-described compositions in the above-described ranges is preferable in order to ensure favorable properties, such as that the glass has excellent workability and fracture resistance, produces less eluted alkali component, and hardly erodes the inner surfaces of a furnace, and the like. Here, note that the glass composition exclusively composed of the above-described compositions refers to a glass composition that contains SiO₂, Al₂O₃, B₂O₃, Na₂O, K₂O, MgO, CaO, and Sb₂O₃, and contains substantially no other components, except for substances that can be treated as impurities.

(About Experiments)

The present inventors have studied in detail the effects of the contents imposed on the glass characteristics, using various kinds of glasses made of CaO and MgO with different contents.

Now, reference will be made to FIG. 2, in which No. 1 represents conventional glass with content of SrO and BaO. No. 2 through No. 11 are glasses of the present invention containing a higher content of Na₂O than that of the conventional glasses. The Na₂O content in No. 1 is 7% by weight, while the Na₂O contents in No. 2 through No. 11 are 14% by weight or more. Of the glasses No. 2 through No. 11, No. 2, No. 3 and No. 11 are glasses for a comparative example of the present invention, while No. 4 through No. 10 represent glasses for the one embodiment of the present invention.

In order to conduct the experiment, the glass compositions No. 1 through No. 11 and lamps having the glass bulbs made of No. 1 through No. 11 were manufactured and evaluated for characteristics inherent therein. Specifically, in terms of glass properties, the glass workability was evaluated by measuring the softening temperature and working temperature. At the same time, the amount of alkali elution was evaluated by measuring at the electrical conductivity. In terms of lamp properties, time-varying changes in amount of Hg consumption during lamp operation and luminous flux of the lamps were observed.

The softening temperature is a temperature at which the glass obtains the viscosity of 10^{7.6} dpa·s, and fluidity. The softening temperature is, preferably, in the range of 670 to 700° C. if the glass in question is adopted for the arc tube. With the softening temperature lower than 670° C., when a binder for phosphor suspension is heated so as to be vaporized in a phosphor baking process, the glass bulb is deformed due to the heat. On the other hand, with that temperature higher than 700° C., the glass bulb should be heated higher than that temperature so as to be bent, which adds the requirement of increasing the combustion capability of manufacturing facilities.

The working temperature is a temperature at which the glass achieves the viscosity of 10⁴ dPa·s, and glass working needs to be performed below the working temperature. The working temperature is, preferably, in the range of 960° C. to 1000° C. if the glass in question is adopted for the arc tube. With working temperature lower than 960° C., workability decreases due to the narrower range of the temperature allowable for glass working. On the other hand, with that temperature higher than 1000° C., the glass starts to melt when the temperature reaches as high as 1000° C., hence increasing costs of performing the melting process.

The electrical conductivity is used to obtain the amount of alkali elution from glass, and in order to obtain glass composition suitable for the arc tube, desirable conductivity is 160 μS/cm or less at 25° C. When the conductivity is higher than 160 μS/cm, various problems arising from the amalgam generation are prominent. Note that the conductivity 160 μS/cm can be translated as the eluted alkali amount of 400 μg/g. Detailed descriptions will be provided below on the relationship between the conductivity and the amount of alkali elution, and the relationship between the conductivity and measuring methods.

The amount of Hg consumed for turning on the lamps was measured overtime. For this measurement, circular florescent lamps categorized in JIS C7601 FCL40/38 (rated power 38 W, glass external diameter 29 mm, lamp diameter 381 mm, color temperature 5000 K) were manufactured using various kinds of glass compositions.

The luminous flux generated when turning on the lamps was 20 measured over time. For this measurement, compact florescent lamps categorized in JIS C 7601 FPL27 (rated power 27 W, glass external diameter 20 mm, lamp's overall length 247 mm, color temperature 5000 K) were manufactured by bridge-connecting two glass tubes while varying glass compositions.

Hereinafter, a description will be made on the glass workability. As shown in FIG. 2, the glass composition No. 1 is inferior in workability as a lamp in that the softening temperature falls below 670° C., and the working temperature exceeds 1000° C., regardless of the fact that No. 1 contains the large amount of SrO and BaO so as to increase the workability.

On the other hand, of the glass compositions No. 2 through No. 11 containing a relatively large amount of Na₂O, No. 3 through No. 10 are superior in workability in that the respective softening temperatures fall within the range of 670° C. to 700° C., and the respective working temperatures fall within the range of 960° C. to 1000° C. The glass composition No. 2 is inferior in workability whose softening temperature does not reach 960° C. The glass composition No. 11 is inferior in workability since the softening temperature exceeds 700° C. From these findings, it can be concluded that the total content of CaO and MgO should be between 7.8% and 11% by weight inclusive so that the glass in question has sufficient workability when adopted for a lamp.

When the glass compositions No. 3 through No. 10 were used so as to form the glass bulb, they exhibited preferable workability as far as the processing such as bending, coupling and sealing were concerned. In addition, decrease in fracture resistance and other related problems caused by residual strain were not observed. Moreover, no abnormality was identified when multiple lamps of varying compositions were manufactured. However, it should be noted that the abnormalities such as deformation and/or cracks were found in the glass composition No. 1 including SrO and BaO. Moreover, No. 2 through No. 11 did not include the expensive ingredients of SrO, BaO, and Li₂O, hence reducing raw material costs for the glass No. 1 in half.

Next, a description will be made on the electronic conductivity of each glass. In FIG. 2, No. 1 represents one example of conventional glass including SrO and BaO, with low content of Na₂O, and exhibits the conductivity of 160 μS/cm or less, which means that the elution of alkali component was sufficiently suppressed.

On the other hand, in FIG. 2, the glass compositions No. 2 through No. 11 are examples of including high content of Na₂O. Of these glasses, the glasses No. 4 through No. 11 containing CaO and MgO with total content more than 8% by weight exhibit the conductivity of 160 μS/cm or less, which means that the elution of alkali component was sufficiently suppressed. Yet, the glasse compositions No. 2 and No. 3 containing CaO and MgO with the total content less than 8% by weight exhibit the conductivity of 160 μS/cm or more, which means that the elution of alkali component was not sufficiently suppressed. As a result, it was found that the total content of CaO and MgO should be 8% by weight or more.

Next, a description will be made on the amount of Hg consumed in a lamp. The Hg consumption was measured after a lamp in question was continuously operating for 6000 hours. The glasses No. 1, No. 4 through No. 11 exhibiting the conductivity of 160 μS/cm or less resulted in the Hg consumption of 2.4 mg or less. On the other hand, No. 2 and No. 3 exhibiting the conductivity of 160 μS/cm or more resulted in the Hg consumption of 2.7 mg or more. Also, as the result of this measurement, it was found that the total content of CaO and MgO should be 8% by weight or more.

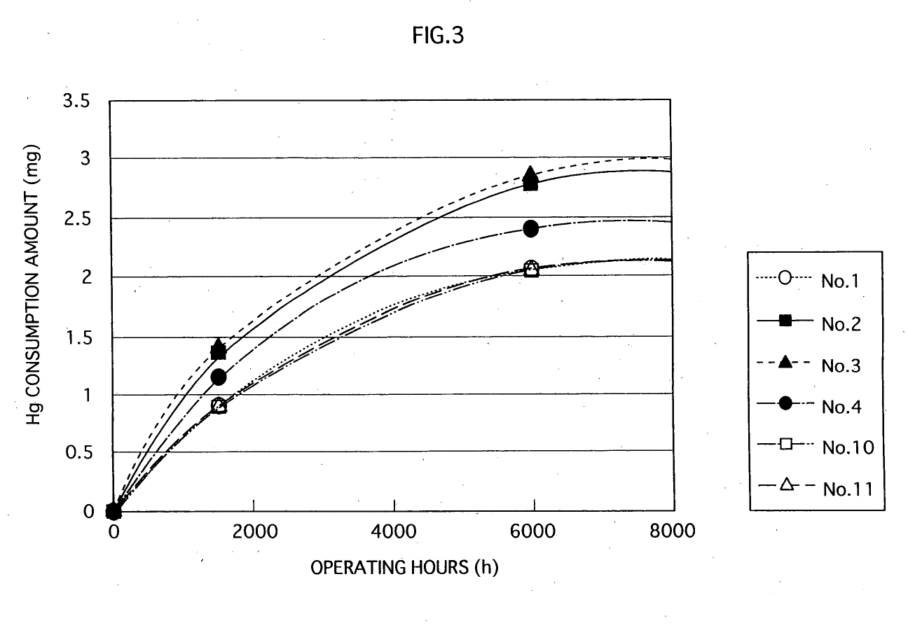

FIG. 3 is a graph showing time-varying change in Hg consumption by the respective lamps. Specifically, the graph shows the Hg consumption by the respective lamps made of the glass compositions No. 1 through No. 4, No. 10, and No. 11 after the lamps were continuously turned on for 1500 hours and 6000 hours. The Hg consumptions in No. 5 through No. 9 were not plotted on the graph since the measurements fall between the Hg consumption of No. 4 and that of No. 10. As clarified in FIG. 3, the Hg consumptions in No. 2 and No. 3 were larger than those of the other lamps, and the differences therebetween became larger as time elapsed.

Next, a description will be made on the lamp's luminous flux. As shown in FIG. 2, the lamps made of the glass compositions No. 1, and No. 4 through No. 11 exhibiting the conductivity of 160 μS/cm or less resulted in the luminous flux exceeding 1500 lm. On the other hand, those of No. 2 and No. 3 exhibiting the conductivity of 160 μS/cm or more resulted in the luminous flux falling below 1500 lm. Also, as the result of this measurement, it was found that the total content of CaO and MgO should be 8% by weight or more.

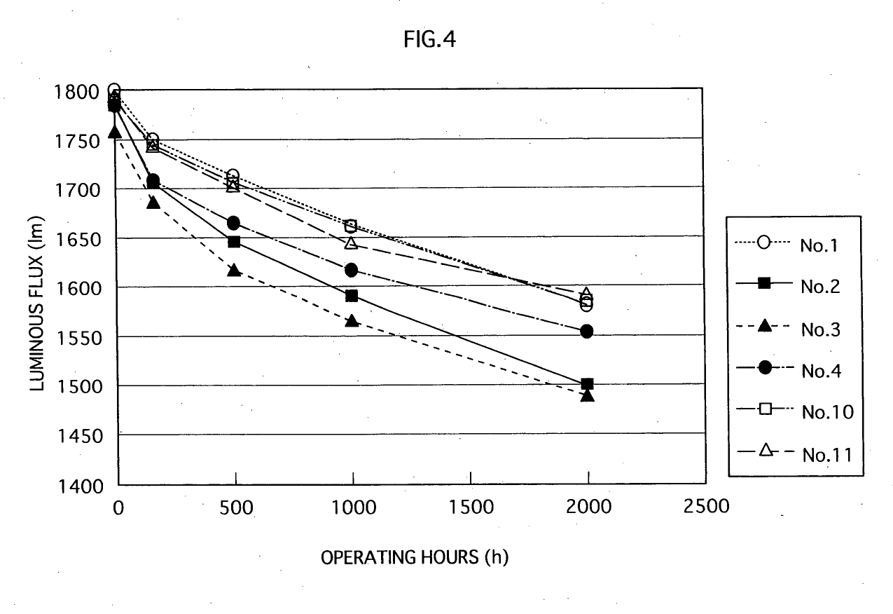

Now, reference will be made to FIG. 4., in which time-varying change in luminous flux of the respective lamps are summarized in a graph. Luminous flux was measured for each glass composition of No. 1 through No. 4, No. 10 and No. 11 under the following conditions: When the lamp in question was switched on, after operating for 100, 500, 1000 hours, and 2000 hours. The luminous fluxes of No. 5 through No. 9 were not plotted on the graph since the differences from No. 4 and No. 10 were so small as to be ignored. As clarified in FIG. 4, the luminous fluxes of the lamps No. 2 and No. 3 were relatively small compared with those of the other lamps, and the differences therebetween became larger as time elapsed.

For the luminous flux measurement, compact florescent lamps of varying compositions were manufactured, categorized in JIS C 7601 FPL27 and accommodating a glass bulb in U shape. The measurement results were almost the same as in FIG. 4.

In summary, based on the results on the glass workability and alkali elution amount, it can be concluded that in order to obtain preferable workability, the total content of CaO and MgO should be in the range of 7.8% to 11% by weight, and in order to sufficiently suppress the amount of alkali elution, the total content of CaO and MgO should be 8% by weight or more. In short, the glass composition suitable for a lamp should include the total content of CaO and MGO in the range of 8% to 11% by weight.

(About Measuring Methods of the Amount of Alkali Elution)

One example of measuring methods for alkali component eluted from glass is called a test method of glass apparatus for chemical analysis (also known as ‘JIS R 3502’). This test will be carried out along the following procedures: a glass test piece is, in the first place, crashed into particles as small as 250 to 420 μm in diameter. These particles are then washed with ethyl alcohol so as to remove unwanted glass powders from the particles. Then, the glass particles are heated in a boiling water bath for 60 minutes so as to obtain alkali eluate by eluting alkali component from the glass particles. After that, the neutralization titration is performed on the alkali eluate using sulfuric acid, and the amount of titration is obtained. Then, the amount of alkali elution is derived therefrom.

However, when using the test method of JIS R 3502, if washing with ethyl alcohol is not sufficient, unwanted glass powders will be left in the glass particles, and hence, due to the presence thereof, the overall surface area of the glass in the distilled water is excessively increased, preventing accurate measurement of the alkali elution. In addition, this test method requires cumbersome operations including crashing a glass test piece into small particles, removing impurities therefrom, conducting neutralization titration, and the like. So in order to address these problems, more accurate and simplified method of measuring the alkali elution amount is desired.

Accordingly, the present inventors have suggested a new method of measuring the alkali elution amount that is more superior in accuracy and ease of operation than the test method of JIS R 3502. In the measuring method of the present invention, block glasses are used as a test piece, and are immersed in distilled water so that alkali eluate is obtained by eluting alkali component from the test pieces into the solvent. After that, the conductivity of the alkali eluate is measured, and then, from that measurement value, the amount of alkali elution is derived.

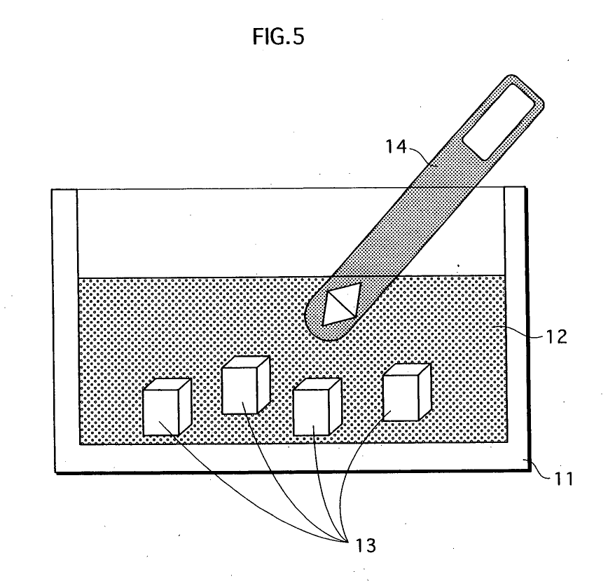

The measuring method of the present invention will be, hereinafter, discussed in detail by referring to FIG. 5, in which an illustration is presented so as to facilitate the understanding on the measuring method of the present invention.

A glass test piece is cut into small blocks, in the first place, and those blocks are placed for 45 to 50 hours in a bath in which temperature and humidity are controlled so as to keep them constantly in the range 75° C. to 85° C. and in the range of 85% to 95%, respectively, and thereby, moisture absorption in the test pieces is accelerated. Note that in order to increase the measurement accuracy, preferable temperature, humidity, and moisture-absorption time are averaged 80° C., 90%, and 48 hours, respectively.

After the moisture absorption is accomplished, distilled water 12 is stored in a bath 11 as shown in FIG. 5, so that glass blocks 13 that have undergone the moisture-absorption process are immersed in the distilled water 12. When the measuring method in accordance with the present invention is used, alkali elution is realized in the distilled water 12 having the relatively low temperature of 70° C. to 80° C., and hence, it is made possible to obtain the alkali elution amount that matches a practical glass usage more than the test method of JIS R 3502.

It is preferable that the glass blocks are immersed in the distilled water so that the total surface area falls in the range of 4500 to 5500 mm². More preferably, the surface area is adjusted so as to be approximately 5000 mm². For example, totaled eight glass blocks, each formed in rectangular solid and having a dimension of approximately 15×15×2.5 mm, are immersed.

After that, those blocks 13 are removed from the distilled water 12 so as to obtain the alkali eluate. While the alkali eluate is set to stable 25° C., the conductivity is measured using a sensor-coupled conductivity measurement device of liquid immersion type 14 (product code: TwinCond B-173) that is generally available in the market.

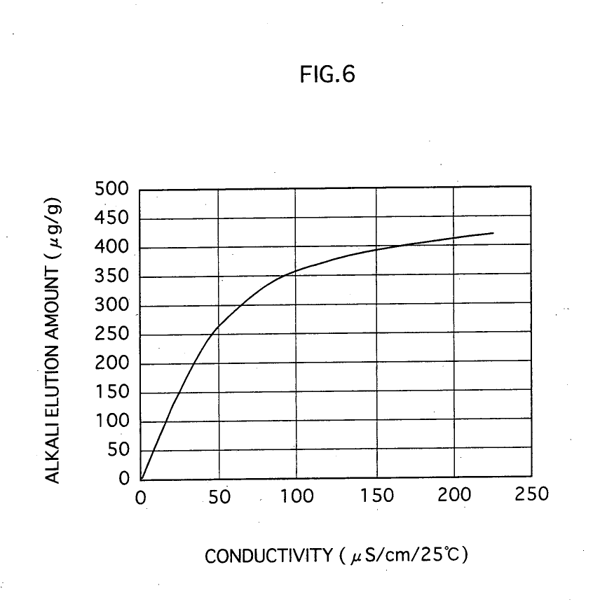

Next, reference will be made to FIG. 6, in which the correlation of the alkali elution amount obtained by using the test method of JIS R 3502 and the conductivity obtained by using the measuring method of the present invention is expressed in a graph. As seen in FIG. 6, the alkali elution amount and conductivity are correlatively related to each other. It is commonly considered that glass compositions with the alkali elution amount of 400 μg/g or less are suitable for the arc tube. Yet, as seen in FIG. 6, the alkali elution amount of 400 μg/g corresponds to the conductivity of 160 μS/cm. In view of this, the glasses exhibiting the conductivity of 160 μS/cm or less are more preferable.

With the adoption of the measuring method in accordance with the present invention, controlling of the total surface area of the glasses to be immersed in the distilled water is facilitated. In this respect, the alkali elution amount is measured with more accuracy than the test method of JIS R 3502. In addition, in the measuring method in accordance with the present invention, the alkali elution amount is measured using the conductivity, hence preventing the decrease in the measurement accuracy.

Moreover, when the measuring method of the present invention is employed, operations such as crashing the test piece into small particles, screening unwanted glass powders, and the like can be eliminated. Furthermore, the measurement of the conductivity of alkali eluate can be carried out with a simple operation of putting electrodes of the conductivity measurement device 14 into the alkali eluate, and accordingly, such an awkward operation of neutralization titration is not required. Therefore, the measuring method of the present invention is more simplified in operation than the test method of JIS R 3502.

### INDUSTRIAL APPLICABILITY

Glass compositions of the present invention are effective in use of various kinds of florescent lamps, incandescent lamps, discharge lamps, and the like, and are, in particular, suitable for lamps such as low-pressure mercury discharge lamps containing a filling of Hg in the arc tubes therein. In addition to these, the glass compositions of the present invention can be adopted for lamps such as U-shaped florescent lamps and compact florescent lamps accommodating the bent glass bulbs.

1. A glass composition for lamps comprising the following that are expressed in terms of oxides:
SiO2 as a main component;
Na2O in a range of 12 to 17% by weight;
MgO in a range of 2.5 to 4% by weight; and
CaO in a range of 5.3 to 7.3% by weight;
wherein MgO and CaO are included with a total content of 8 to 11% by weight.

2. The glass composition of claim 1,
wherein SiO2 is contained in a range of 65 to 74% by weight,
the glass composition further comprising:
Al2O3 in a range of 1.2 to 2.4% by weight;
B2O3 in a range of 0.3 to 1.5% by weight;
K2O in a range of 0.9 to 1.9% by weight; and
Sb2O3 in a range of 0 to 1% by weight.

3. The glass composition of claim 1,
wherein substantially no PbO, SrO, and BaO are included therein.

4. The glass composition of claim 2,
wherein substantially no PbO, SrO, and BaO are included therein.

5. A lamp comprising:
a glass bulb that is manufactured from the glass composition of claim 1.

6. The lamp of claim 5, being a low-pressure mercury discharge lamp.

7. The lamp of claim 5,
wherein the glass bulb is a bent glass bulb.

8. The lamp of claim 6,
wherein the glass bulb is a bent glass bulb.

9. A lamp comprising:
a glass bulb that is manufactured from the glass composition of claim 2.

10. A lamp comprising:
a glass bulb that is manufactured from the glass composition of claim 3.

11. A lamp comprising:
a glass bulb that is manufactured from the glass composition of claim 4.
